(19) United States
(12) Patent Application Publication
(10) Pub. No.: US 2002/0156919 A1
(43) Pub. Date: Oct. 24, 2002

(54) Communications network for routing a message via single virtual link representing its reachable extent within a subnetwork

(76) Inventor: Yoshiharu Maeno, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/126,872

(22) Filed: Apr. 22, 2002

(30) Foreign Application Priority Data
Apr. 23, 2001 (JP) 2001-123700
Aug. 2, 2001 (JP) 2001-234354

(51) Int. Cl. G06F 15/173

(52) U.S. Cl. 709/238

(57) ABSTRACT

In a communications network which includes a subnetwork and at least one external node, each node of the subnetwork calculates virtual links from physical links of the subnetwork so that they emanate to other nodes of the subnetwork and advertises the calculated virtual links as reachable extents of each node within the subnetwork. The external node receives the advertised messages and maintains them in a database. On receiving a path setup request from a client device, the external node uses the database to determine a route to a destination and transmits a connection setup message to a border node of the subnetwork. On receiving the setup message, the border node establishes a connection over the determined route by using only one virtual link of the advertised links.

### BACKGROUND OF THE INVENTION

1. Field of the Invention

The present invention relates generally to communications networks and more specifically to a path establishment technique. This invention is particularly useful to a network of optical cross-connect nodes.

2. Description of the Related Art

In an optical communications network in which optical cross-connect nodes are interconnected by optical fibers, a routing protocol such as OSPF (open shortest path first) is used for route calculations. With the OSPF routing protocol, no consideration is taken into route calculations as to the operating parameters of optical links which are usually subject to their physical parameters (such as attenuation, dispersion and nonlinearity) and their length. However, such operating parameters are of the nature too complex to be taken into route calculations. If messages are transmitted transparently within the network, i.e., with no compensation for signal degradation, proper transmission cannot be ensured for all possible routes.

### SUMMARY OF THE INVENTION

It is therefore an object of the present invention to provide a technical solution for a transparent communications network such as optical network whose operating parameters are subject to the physical parameters and the length of transmission medium and whose complexity cannot lend themselves to route calculations.

According to a first aspect of the present invention, there is provided a communications network comprising a subnetwork of network nodes interconnected by physical links, each of the network nodes calculating a plurality of virtual links from the physical links so that the virtual links emanate to other nodes of the subnetwork and transmitting a link state advertisement message for advertising the calculated virtual links, each of the virtual links representing a reachable extent of each network node within the subnetwork, and a network node external to the subnetwork, the external network node being connected to a border node of the subnetwork for receiving the link state advertisement message and maintaining the advertised virtual links in a database. The external network node, upon receipt of a path setup request from a client device, determines a route to a destination by using the virtual links in the database and transmits a connection setup message. On receiving the connection setup message, the border node of the subnetwork establishes a connection over the determined route by using only one virtual link of the advertised links.

According to a second aspect the present invention provides a communications network comprising a first subnetwork of network nodes interconnected by physical links, each of the network nodes calculating a plurality of virtual links from the physical links so that the virtual links emanate to other nodes of the subnetwork and transmitting a link state advertisement message for advertising the calculated virtual links, each of the virtual links representing a reachable extent of each network node within the subnetwork, and a plurality of second subnetworks, each comprising a plurality of network nodes interconnected by links, each of the second subnetworks including a border node which is connected to a corresponding one of a plurality of border nodes of the first subnetwork. The border node of each of the second subnetworks receives the link state advertisement message and maintains the advertised virtual links in a database, and upon receipt of a path setup request from a client device, determines a route to a destination by using the virtual links in the database and transmits a connection setup message. One of the border nodes of the first subnetwork receives the connection setup message and establishes a connection over the determined route by using only one virtual link of the advertised links.

According to a third aspect, the present invention provides a border network node for a communications network in which the node is one of a plurality of network nodes which are interconnected by physical links to constitute a subnetwork, and wherein the communications network includes a further network node connected to the border network node as an external node of the subnetwork. The border network node comprises a switch and processing circuitry for calculating a plurality of virtual links from the physical links so that the virtual links emanate to other nodes of the subnetwork, and advertising the calculated virtual links to the external network node for advertising the calculated virtual links to allow the external network node to determine a route, each of the virtual links representing a reachable extent of the border network node within the subnetwork. Upon receipt of a connection setup message from the external network node, the processing circuitry establishes a connection in the switch so that the external network node is connected via the switch to a destination by using only one virtual link of the advertised links,

According to a fourth aspect, the present invention provides a method of communication for a communications network, which comprises a subnetwork of network nodes interconnected by physical links and a network node external to the subnetwork. The method comprises the steps of (a) calculating, at each node of the subnetwork, a plurality of virtual links from the physical links so that the virtual links emanate to other nodes of the subnetwork, each of the virtual links representing a reachable extent of each network node within the subnetwork, and transmitting a link state advertisement message for advertising the calculated virtual links, (b) receiving, at the external network node, the link state advertisement message to maintain the advertised virtual links in a database, (c) determining, at the external network node, a route to a destination, upon receipt of a pat setup message from a client device, by using the virtual link in the database and transmitting a connection setup message, and (d) establishing, at a border node of the subnetwork, a connection over the determined route, upon receipt of the connection setup message from the external node, by using only one virtual link of the advertised links

### BRIEF DESCRIPTION OF THE DRAWINGS

The present invention will be described in detail further with reference to the following drawings, in which:

FIG. 1 is a block diagram of an optical communications network of the present invention;

FIG. 2 is a block diagram of an electrical cross-connect (ECX) node of the present invention;

FIG. 3 is a block diagram of an optical cross-connect (OCX) node of the present invention;

FIG. 4A is a flowchart of the operation of an OXC node for advertising LSA (link state advertisement) messages during a neighbor discovery or service discovery process;

FIG. 4B is a flowchart of the operation of EXC and OXC nodes when an LSA message is received;

FIGS. 5A and 5B are illustrations of the data structure of LSA messages transmitted from OXC nodes of FIG. 1;

FIG. 6 is an illustration of the link state database of a cross-connect node, indicating advertised status of virtual links;

FIG. 7 is a flowchart of the operation of an EXC node when it receives a path setup request from a client device;

FIG. 8 is a flowchart of the operation of an OXC node located at the border of a transparent subnetwork according to a new protocol when it receives a connection setup message from a neighbor EXC node;

FIG. 9 is a flowchart of the operation of the border OXC node according to the known protocol when it receives a connection setup message from a neighbor EXC node;

FIG. 10 is a flowchart of the operation of an OXC node for reflecting changes in physical links into virtual links when physical links are used for communication or shutdown due to cable failure; and

FIG. 11 is a block diagram of the optical communications network configured to share the same domain with OXC nodes and EXC nodes.

### DETAILED DESCRIPTION

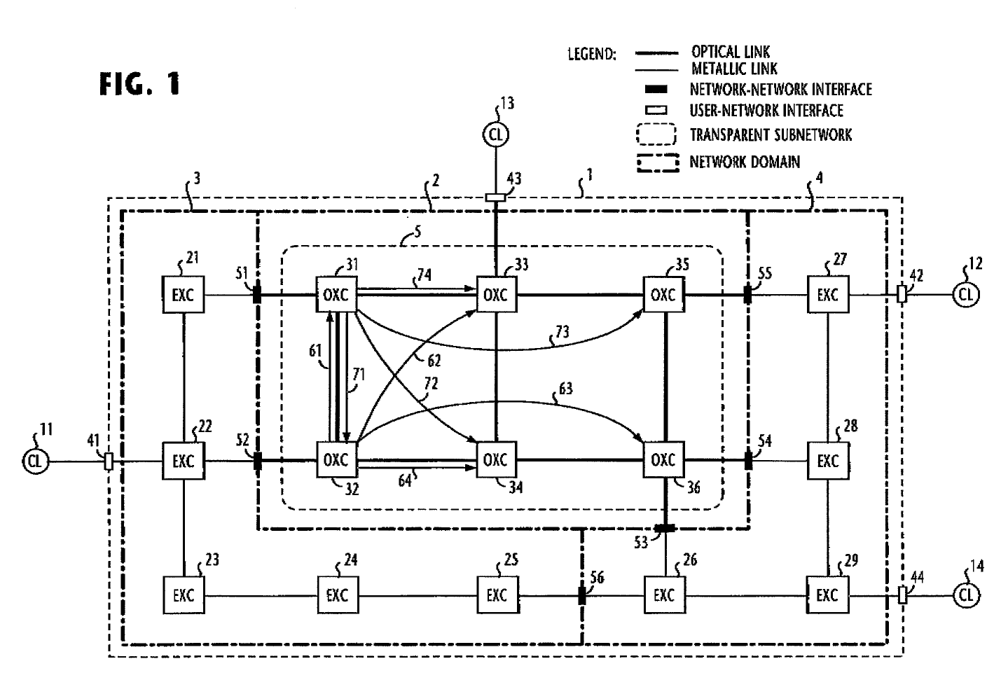

Referring now to FIG. 1, there is shown an optical communications network incorporating a number of embodiments of the present invention. Within the optical communications network, as indicated by numeral 1, a number of network domains 2, 3 and 4 are defined. Network domain 2 includes a transparent subnetwork (or transparent transmission cloud) 5 comprising optical cross-connect (OXC) systems 31˜36 interconnected by physical optical links indicated by solid thick lines. Within the transparent subnetwork 5, all signals are transmitted “transparently” i.e., without undergoing electro-optical or opto-electrical conversion process.

Network domain 3 is a first electrical subnetwork comprising electrical cross-connect (EXC) systems 21˜25, and the domain 4 is a second electrical subnetwork comprising electrical cross-connect (EXC) systems 26˜29. All the EXC nodes are interconnected by metallic links indicated by solid thin lines. All network domains are interfaced to each other by network-network interfaces (NNI) 51˜56 which are located at the boundaries between adjacent domains, and more specifically, they are located in the line interfaces of the OXC nodes 31, 32, 35 and 36.

Client devices 11, 12 and 14 are connected to the EXC nodes 22, 27 and 29 via user-network interfaces (UNI) 41, 42, 44, respectively, and a client device 13 is connected by a UNI 43 to the OXC node 33. Each of these user-network interfaces is located at the line interface of the EXO systems 22, 27, 29 and the OXC node 33.

Prior to the startup of the optical network 1, a network management center, not shown, performs a management function by selecting all possible routes within the domain 2 according to a predefined route optimization index based on transmission parameter data gained from computer simulations and experiments on the fiber optics cables used, and verifies the transmission quality of all optical links of the selected routes in terms of bit error rate, signal-to-noise ratio and the Q value. If the error bit rate of an optical route from a given OXC node is higher than 10⁻⁹, for example, it is determined that the optical route is beyond the reachable extent of the given OXC node. Data indicating the verified transmission quality of the optical links are stored in a database as indications of reachable extents from each OXC node within the transparent domain 2, or transmitted to each OXC node.

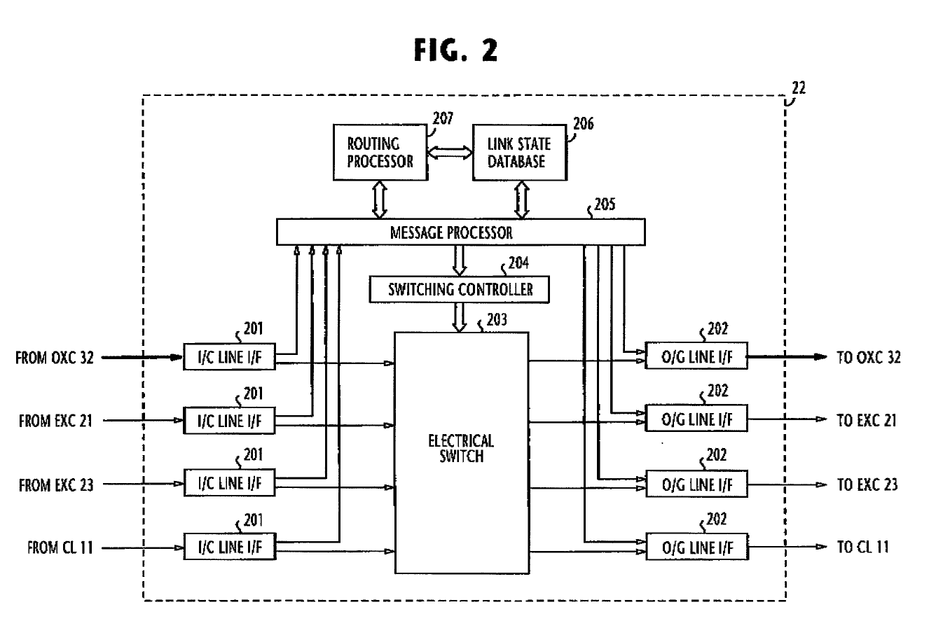

Details of the EXC node 22 are illustrated in FIG. 2 as a representative of the EXC nodes of the present invention. EXC node 22 is comprised of a plurality of incoming (I/C) line interfaces 201 and a plurality of outgoing (O/G) line interfaces 202. These line interfaces are connected to the OXC node 32, EXC nodes 21, 23 and the client device 11. Opto-electrical and electro-optical conversion is performed in some of these line interfaces that interfaces optical links. Between the incoming and outgoing line interfaces is an electrical switch 203 through which incoming signals are switched to an appropriate cross-connect node under control of a switching controller 204. A message processor 205 is provided to receive control messages from the incoming line interfaces 201. Message processor 205 formulates a control message for retransmission to downstream nodes via the outgoing line interfaces 202 and supplies a switching signal to the switching controller 204. Based on the switching signal, the switching controller 204 establishes a connection in the electrical switch 203.

Further connected to the message processor 205 are a link state database 206 and a routing processor 207. Via the message processor 205, the link state database 206 receives link state advertisement (LSA) messages from neighbor cross-connect nodes in order to maintain the status of metallic links. Routing processor 207 uses the OSPF (open shortest path first) routing protocol and the like to perform optimum route calculations based on the link status data in the database 206 and control (path setup and release) messages it receives from the client device via the message processor 205. Routing processor 207 supplies a routing signal to the message processor 205 for indicating the determined route to allow the processor 205 to produce the switching signal as mentioned above for application to the switching controller 204.

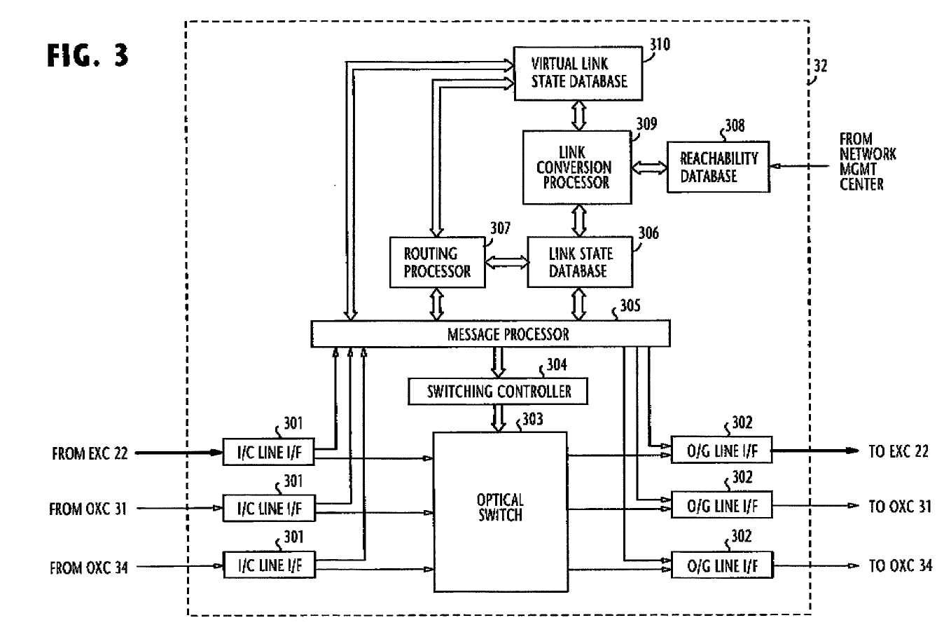

Details of the OXC node 32 are illustrated in FIG. 3 as a representative of the OXC nodes of the present invention. OXC node 32 is comprised of a plurality of incoming line interfaces 301 and a plurality of outgoing line interfaces 302. These line interfaces are connected to the EXC node 22 and the OXC nodes 31 and 34. Opto-electrical and electro-optical conversion is provided in some of these line interfaces that interfaces optical links. Between the incoming and outgoing line interfaces is an optical switch 303 through which incoming signals are switched to an appropriate cross-connect node under control of a switching controller 304. A message processor 305 receives control messages from the incoming line interfaces 301 and formulates control messages for retransmission to downstream nodes via the outgoing line interfaces 302 and supplies a switching signal to the switching controller 304. Based on the switching signal, the switching controller 304 establishes a connection in the optical switch 303.

Message processor 305 is further connected to a link state database 306 and a routing processor 307. Via the message processor 305, the link state database 306 receives LSA messages from neighbor cross-connect nodes and maintains the status of physical links. A reachability database 308 receives data from the network management center, indicating the reachable extent of each OXC node in the transparent subnetwork 5, as mentioned previously. A link conversion processor 309 is provided for relationships between a plurality of virtual links and corresponding sets of physical links within the transparent subnetwork 5 based on data supplied from the link state database 306 and the reachability database 308. As a result, each virtual link of a given OXC node ensures that a distant OXC node can be reached from the given OXC node with a high level of transmission quality. The link status data of t the virtual links within the subnetwork 5 are maintained in the virtual link state database 310. Based on the data stored in the databases 306 and 310, the routing processor 307 calculates an optimum route in response to a connection setup message from a neighbor cross-connect node and supplied a routing signal to the message processor 305, indicating the calculated route. Routing processor 307 uses the OSPF routing protocol and the like to perform optimum route calculations based on the virtual link database 310 and IS control messages it receives from a neighbor cross-connect node via the message processor 305. Routing processor 307 supplies a routing signal to the message processor 305 to establish a connection in the optical switch 303.

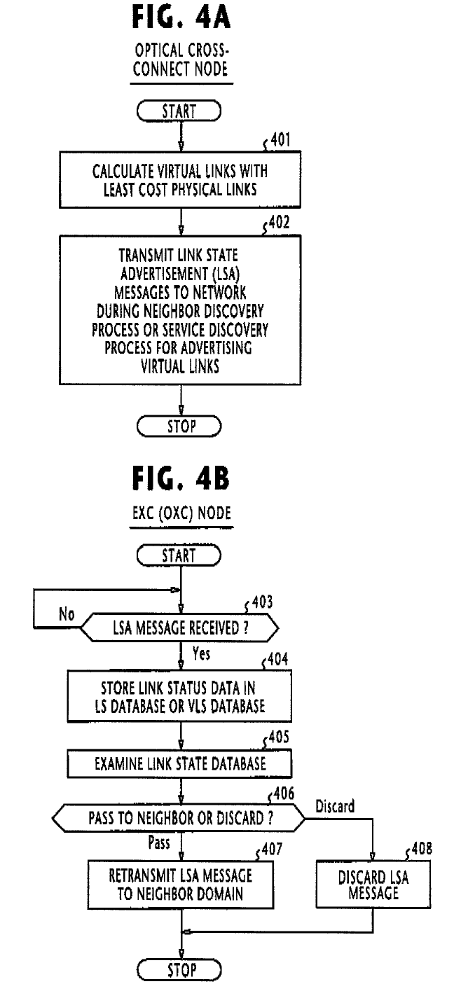

During a neighbor discovery process or a service discovery process of the OSPF protocol when the optical network 1 is started, the message processor 305 calculates virtual links that emanate from its own OXC node with least cost physical links (step 401, FIG. 4A) and advertises an LSA message to the network, indicating the calculated virtual links (step 402).

In a preferred embodiment, link state advertisement (LSA) messages are transmitted to a limited number of domains by specifying an “advertisement scope” In comparison with network-wide advertisement, the advertisement scope has the effect of reducing the traffic burden of the control channels of the network for transporting LSA messages by specifying domains to be advertised. The advertisement scope may be defined within the link state (LS) database 206 and the virtual link state (VLS) database 310.

In FIG. 4B, when each of the EXC and OXC nodes of the network receives an LSA message (step 403), the received data is stored in the link state database or virual link state database (step 404). The cross-connect node examines the stored advertisement scope data (step 405) and determines whether the LSA message is to be retransmitted to a neighbor domain or discarded. If it is determined that the message is to be retransmitted, the received message is forwarded to the neighbor domain (step 407). Otherwise, the message is discarded (step 408).

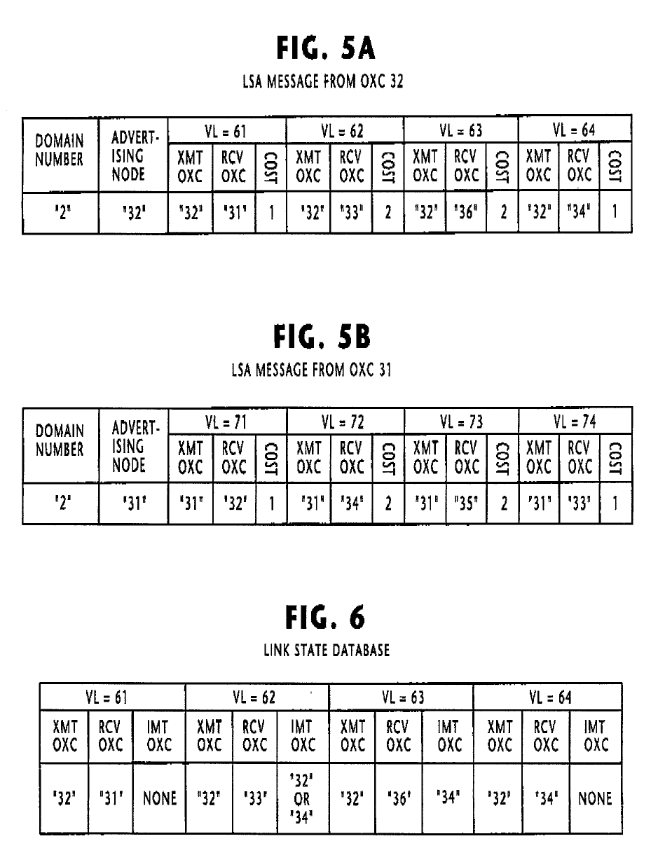

Assume that the transmission quality of a transparent route from the OXC node 32 to the OXC node 35 is beyond the reachable extent of the former since the data obtained during the initial computer simulations and experiments and communicated from the network management center indicates that the quality of the transparent route is lower than the standard. Therefore, the reachable extents of OXC node 32 may be indicated by virtual links 61˜64 as shown in FIG. 1 and advertised from the OXC node 32 with an LSA message (see FIG. 5A). The LSA message contains a plurality of entries each containing a pair of node identifiers identifying a source node and a destination node between which a virtual link is established and the transmission cost of the virtual link. In like manner, the reachable extents of OXC node 31 may be indicated by virtual links 71˜74 in FIG. 1, and advertised from the OXC node 31 with an LSA message (see FIG. 5B).

FIG. 6 shows the virtual link status data advertised the network from the OXC 32 and maintained by all OXC nodes of the transparent subnetwork 5 as well as by all EXC nodes of the defined advertisement scope. The virtual link status data includes a plurality of entries each containing a pair of node identifiers identifying source and destination nodes between which a virtual link is established and the node identifier of a transit node, if any, by way of which the virtual link is established. The virtual link status data may also be maintained in the network management center. Each entry of the virtual link status data may also include the identifiers of the incoming and outgoing line interfaces of the transit node and the identifier of a wavelength channel. If each of the physical links that comprise a virtual link is identified by a set of a fiber optics number and a wavelength number, such identifiers may be used to identify a physical link. Thus, the virtual link 63 between OXC nodes 32 and 36 can be recognized as using the OXC node 34 as a transit node, making it possible to convert a virtual link to its component physical links.

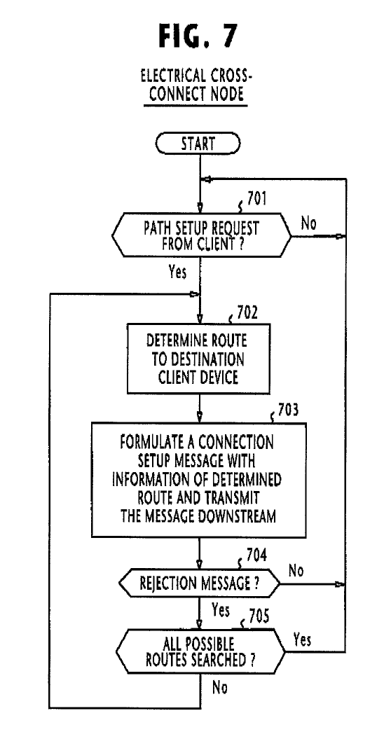

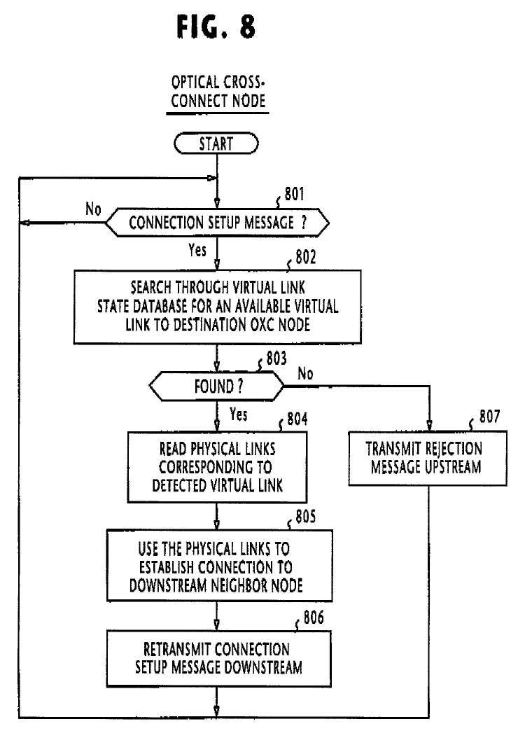

The optical network 1 operates on a new protocol which proceeds according to the flowcharts of FIGS. 7 and 8.

In FIG. 7, when a client device sends a path setup request to the network, an EXC node adjacent to that client device receives the request message (step 701), and operates as a source EXC node by calculating a route to the destination client device based on the link status data advertised and maintained in the link state database 206 (step 702). Then, the source EXC node formulates a connection setup message with the routing information of the determined route and transmits the connection setup message to a downstream node (step 703). Following the transmission of a connection setup message, flow proceeds to decision step 704 to check to see if a rejection message is received from the downstream node. If there is one, the EXC node determines if all possible routes to destination have been searched. If the decision is negative, flow returns to step 702 to repeat the route determination process. If no rejection message has been received (step 704) or all possible routes have been searched (step 705), the EXC node returns to the starting point of the routine.

In FIG. 8, the transmitted connection setup message is received by an OXC node located downstream of the source EXC node (step 801). At step 802, the OXC node searches through the virtual link state database 310 for an available virtual link to the destination OXC node. If such a link is found (step 803), flow proceeds to step 804 to read physical links corresponding to the detected virtual link and establishes a connection to the neighbor OXC node (step 805). The OXC node then retransmits the connection setup message downstream (step 806).

Since each virtual link of the transparent subnetwork 5 serves as an indication of the reachable extent of a transmission route from a source OXC node within that subnetwork that meets the required channel quality, the required channel quality is ensured if the established connection uses only one virtual link.

If the OXC destination node is beyond the reachable extent of the source node, no virtual links are available and the source EXC node makes a further search for an OXC node by way of whit the destination node can be reached. Therefore, if an available link is not found at step 803, the OXC node proceeds to step 807 and transmits a rejection message to the upstream node to cause it to make a further search for an available route, and returns to the starting point of the routine.

Assume that the client device 11 establishes a connection to the client device 12 using the new protocol, it sends a request message to the border EXC 22. In response, the EXC 22 determines a route of a least total hop number by using the virtual link status information of FIGS. 5A and 5B which have been advertised from the OXC 32 to the domain 3 and maintained in the link state database 206. Since there is no virtual link between the OXC nodes 32 and 36, the EXC 22 may determine a 5-hop route that includes the virtual link 63 between the OXC nodes 32 and 36 and the metallic links concatenated by nodes 36,28 and 27, and sends a connection setup message to the OXC 32, containing the determined route information. In response, the OXC 32 makes a search through the virtual state database 310 and determines whether the virtual link 63 of the 5-hop route is available or not. If the physical link between OXC nodes 32 and 34 is shared in common by the virtual links 63 and 64 and the latter is in use by another connection, the virtual link 63 may be unavailable and the OXC 32 sends back a rejection message to the EXC 22. If the virtual link 63 is available, the OXC 32 reads the physical links of the virtual link 63, and establishes a connection to the OXC node 34 and transmits a connection setup message downstream. According to the connection setup message from the OXC node 32, the OXC node 34 establishes a connection to the OXC node 36 and retransmits the message to the EXC node 28, which repeats the same process by establishing a connection to the EXC node 27 and retransmitting the message downstream. EXC node 27 responds to the connection setup message from the EXC node 28 by establishing a connection to the destination client device 12.

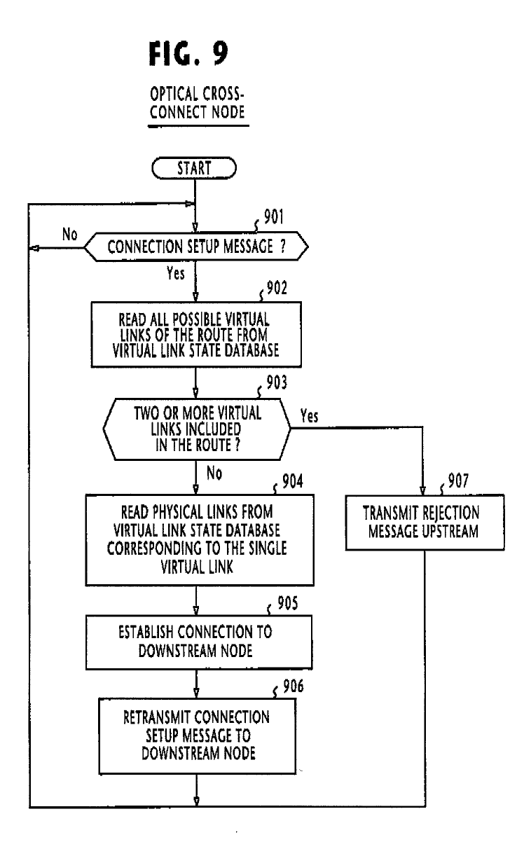

The optical network 1 may operate on the known protocol which does not discriminate between virtual links and physical links. When the known protocol is used, the operation of the OXC nodes proceeds according to the flowchart of FIG. 9.

In FIG. 9, when the border OXC node, such as OXC node 32, receives a connection setup message from the source EXC node, such as EXC 22, it reads all possible virtual links of the route indicated in the received message from the virtual link state database 310 (step 902). At step 903, the OXC determines whether two or more virtual links are included in the route. If there is only one virtual link, the decision at step 903 is negative and flow proceeds to step 904 to read a set of physical links from the virtual link state database 310 corresponding to the single virtual link. At step 905, the OXC node uses the physical links to establish a connection to the downstream neighbor node, and retransmits the connection setup message downstream (step 906), and returns to the starting point of the routine.

Although a virtual link ensures that a high quality transmission is possible between two OXC nodes, the concatenation of two or more virtual links does not. Therefore, if two or more virtual links are included in the route indicated in a connection setup message, flow proceeds from step 903 to step 907 and transmits a rejection message to the upstream node to cause it to select an alternate route.

If the client device 11 establishes a connection to the client device 12 and sends a request message to the border EXC node 22 which uses the known protocol, no distinction is made between virtual and physical links. If the EXC node 22 selects a 5-hop route connected by the virtual links 61 and 73 to the EXC node 27, and sends a connection setup message to the border OXC 32, the latter sends back a rejection message to the upstream EXC node 27 because of the concatenation of two virtual links. In response to this rejection message, the EXC node 22 performs a route recalculation and may select a route through the virtual link 63 and the metallic links concatenated by the nodes 36,28 and 27.

Since physical links of least cost pairs that can be used to form virtual links within the transparent subnetwork 5 may vary with time, it is preferable that the virtual links be updated with the changing states of the physical links.

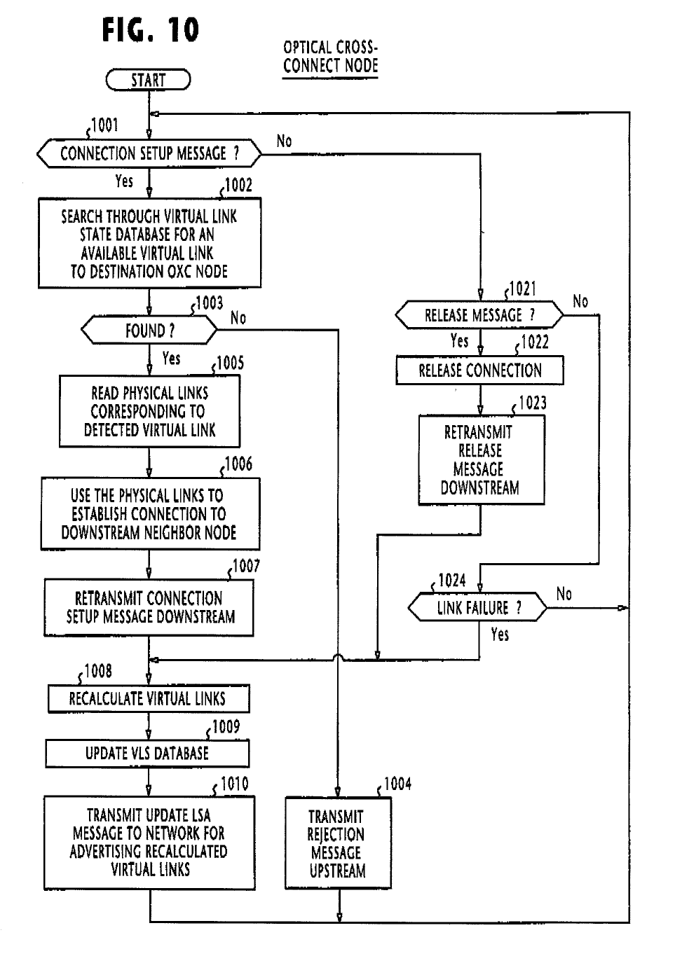

The OXC node operates according to the flowchart of FIG. 10. When an OXC node receives a connection setup message from a source EXC node (step 1001), it makes a search through the virtual link state database 310 for an is available virtual link to the destination OXC node (step 1002). If such a link is not found (step 1003), flow proceeds to step 1004 to transmit a rejection message to the source EXC node. If an available virtual link exists, a set of physical links are read from the virtual link state database 310 corresponding to the detected virtual link (step 1005) and a connection is established to the neighbor OXC node using the set of physical links (step 1006). The OXC node then retransmits the connection setup message downstream (step 1007).

At step 1008, the OXC node recalculates virtual links by excluding the physical links currently in use, and updates the virtual link state (VLS) database 310 with the recalculated virtual link data (step 1009). At step 1010, the OXC node transmits an update LSA message to the network for advertising the recalculated virtual links.

When a connection release message is received from the source EXC node (step 1021), the connection is released (step 1022) and the received message is retransmitted downstream (step 1023). Following the retransmission of the release message, the OXC node proceeds to step 1008 to recalculate the virtual links, updates the VLS database (step 1009) and transmits an update LSA message to the network (step 1010).

Since the physical links are subject to cable failures, it is further preferable that the states of the virtual links be updated with the occurrence of a cable fault. When a physical link of the OXC node has failed (step 1024), the OXC node recalculates virtual links (step 1008) and transmits an update ISA message to the network for advertising the recalculated virtual links (step 1010).

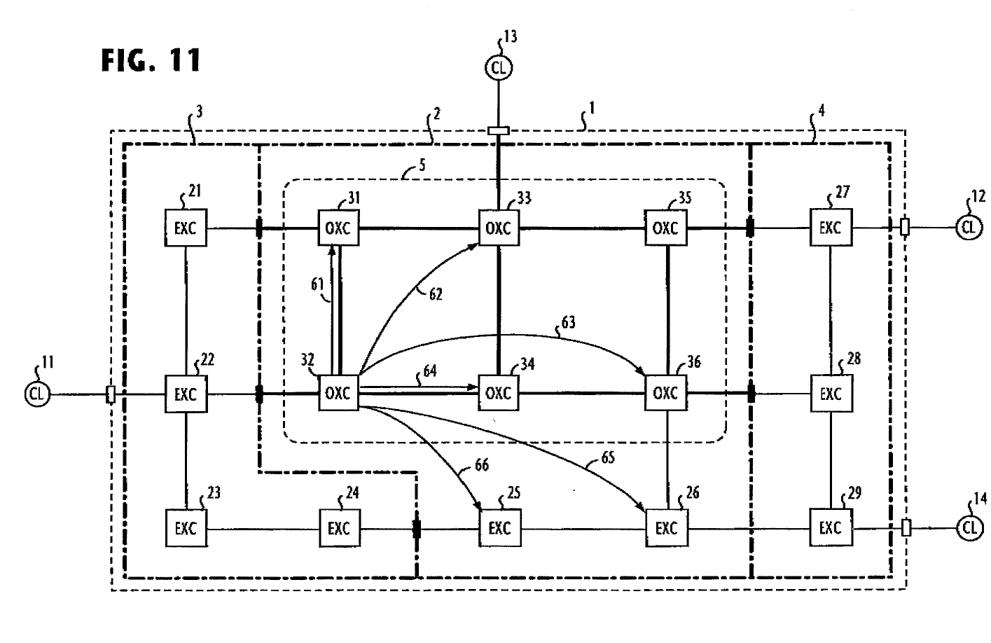

The optical communications network 1 may be configured as shown in FIG. 11 in which the domain 2 is expanded to include the EXC nodes 25 and 26. In addition to the virtual links 61 to 64, additional virtual links 65 and 66 are provided between the OXC 32 and the EXC nodes 26 and 25. According to this configuration, the EXC nodes 25 and 26 are additionally provided with the reachability database 308, link conversion processor 309 and virtual link state database 310 of FIG. 3, all of which are connected to the message processor 205. In the configuration of FIG. 1, the OXC node 35 is beyond the reachable extent of the OXC node 32. However, due to the presence of the virtual link 65 to the EXC node 26 which is capable of quality improvement by amplification and the like, the OXC node 32 is able to reach the OXC node 35 via the EXC node 26 and OXC node 36.

What is claimed is:

1. A communications network comprising;
a subnetwork of network nodes interconnected by physical links, each of the network nodes calculating a plurality of virtual links from said physical links so that the virtual links emanate to other nodes of the subnetwork and transmitting a link state advertisement message for advertising the calculated virtual links, each of the virtual links representing a reachable extent of each network node within the subnetwork; and
a network node external to said subnetwork, the external network node being connected to a border node of the subnetwork for receiving said link state advertisement message and maintaining the advertised virtual links in a database,
the external network node, upon receipt of a path setup request from a client device, determining a route to a destination by using the virtual links in said database and transmitting a connection setup message,
said border node of the subnetwork, upon receipt of the connection setup message, establishing a connection over the determined route by using only one virtual link of the advertised links.

2. The communications network of claim 1, wherein the subnetwork comprises a transparent subnetwork.

3. The communications network of claim 1, wherein the network it nodes of said subnetwork comprise optical cross-conned nodes interconnected by optical links.

4. The communications network of claim 1, wherein the network nodes of said subnetwork comprise optical cross-connect nodes interconnected by optical links and an electrical cross-connect node connected to the optical cross-connect nodes by a metallic link.

5. The communications network of claim 3, wherein the external network node comprises an electrical cross-connect node.

6. The communications network of claim 1, wherein the external network node retransmits the link state advertisement message to other external nodes or discard the message, depending on a predefined advertisement scope.

7. The communications network of claim 1, wherein the border node of the subnetwork transmits a rejection message to the external network node when there is no available virtual link to said destination.

8. The communications network of claim 1, wherein the border node of the subnetwork transmits a rejection message to the external network node when said connection setup message contains two or more of said virtual links.

9. The communications network of claim 1, wherein each of the virtual links has a minimum of link costs which would otherwise be incurred by possible candidate physical links.

10. The communications network of claim 9, wherein each of the network nodes of the subnetwork recalculates said virtual links when one of the virtual links becomes unavailable for use and transmits an update link state advertisement message for indicating the unavailability of the virtual link, and wherein the external network node receives the update link state advertisement message and updates said database according to the received message.

11. The communications network of claim 10, wherein each of the network nodes of the subnetwork recalculates said virtual links when said a unavailable virtual link becomes available for use and transmits an update link state advertisement message for indicating the availability of the virtual link, and wherein the external network node receives the update link state advertisement message and updates said database according to the received message.

12. A communications network comprising:
a first subnetwork of network nodes interconnected by physical links, each of the network nodes calculating a plurality of virtual links from said physical links so that the virtual links emanate to other nodes of the subnetwork and transmitting a link state advertisement message for advertising the calculated virtual links, each of the virtual links representing a reachable extent of each network node within the subnetwork; and
a plurality of second subnetworks, each comprising a plurality of network nodes interconnected by links, each of the second subnetworks including a border node which is connected to a corresponding one of a plurality of border nodes of the first subnetwork,
the border node of each of the second subnetworks receiving said link state advertisement message and maintaining the advertised virtual links in a database, and upon receipt of a path setup request from a client device, determining a route to a destination by using the virtual links in said database and transmitting a connection setup message,
one of the border nodes of the first subnetwork receiving the connection setup message and establishing a connection over the determined route by using only one virtual link of the advertised links.

13. The communications network of claim 12, wherein each of the network nodes of the first subnetwork comprises an optical node which transparently transmits optical signals and each of the network nodes of the second subnetwork comprises an electrical node which transmits electrical signals by compensating for signal degradation.

14. The communications network of clam 13, wherein the first subnetwork further comprises electrical nodes interconnected by metallic links for transmitting electrical signals by compensating for signal degradation.

15. The communications network of claim 13, wherein each of the network nodes of the second subnetwork retransmits the link state advertisement message to other external nodes or discard the message, depending on a predefined advertisement scope.

16. The communications network of claim 13, wherein each of the border nodes of the first subnetwork transmits a rejection message to a corresponding border node of the second subnetworks when there is no available virtual link to said destination.

17. The communications network of claim 13, wherein each of the border nodes of the first subnetwork transmits a rejection message to a corresponding border node of the second subnetworks when said connection setup message contains two or more of said virtual links.

18. The communications network of claim 13, wherein each of the virtual links has a minimum of link costs which would otherwise be incurred by possible candidate physical links.

19. The communications network of claim 18, wherein each of the network nodes of the first subnetwork recalculates said virtual links when one of the virtual links becomes unavailable for use and transmits an update link state advertisement message for indicating the unavailability of the virtual link, and wherein each of the border nodes of the second subnetworks receives the update link state advertisement message and updates said database according to the received message.

20. The communications network of claim 19, wherein each of the network nodes of the first subnetwork recalculates said virtual links when said unavailable virtual link becomes available for use and transmits an update link state advertisement message for indicating the availability of the virtual link, and wherein each of the border nodes of the second subnetworks receives the update link state advertisement message and updates said database according to the received message.

21. A border network node for a communications network in which said node is one of a plurality of network nodes which are interconnected by physical links to constitute a subnetwork of said communications network, and wherein said communications network includes a further network node connected to the border network node as an external node of the subnetwork, the border network node comprising:
a switch; and
processing circuitry for calculating a plurality of virtual links from said physical links so tat the virtual links emanate to other nodes of the subnetwork, and advertising the calculated virtual links to the external network node for advertising the calculated virtual links to allow said external network node to determine a route, each of the virtual links representing a reachable extent of the border network node within said subnetwork,
the processing circuitry, upon receipt of a connection setup message from said external network node, establishing a connection in said switch so that the external network node is connected via said switch to a destination by using only one virtual link of the advertised links.

22. The border network node of claim 21, wherein said switch comprises an optical switch.

23. The border network node of claim 21, wherein the subnetwork comprises a transparent subnetwork.

24. The border network node of claim 21, wherein said processing circuitry transmits a rejection message to the external network node when said connection setup message contains two or more of said virtual links.

25. The border network node of claim 21, wherein each of the virtual links has a minimum of link costs which would otherwise be incurred by possible candidate physical links.

26. The border network node of claim 25, wherein said processing circuitry recalculates said virtual link when one of the virtual link becomes unavailable for use and advertises the unavailability of the virtual link to the external network node.

27. The border network node of claim 26, wherein said processing circuitry recalculates said virtual links when said unavailable virtual link becomes available for use and advertises the availability of the virtual link to the external network node.

28. A method of communication for a communications network, which comprises a subnetwork of network nodes interconnected by physical links and a network node external to said subnetwork, the method comprising the steps of:
a) at each node of the subnetwork, calculating a plurality of virtual links from said physical links so that the virtual links emanate to other nodes of the subnetwork, each of the virtual links representing a reachable extent of each network node within the subnetwork, and transmitting a link state advertisement message for advertising the calculated virtual links;
b) at said external network node, receiving said link state advertisement message to maintain the advertised virtual links in a database;
c) at said external network node, determining a route to a destination, upon receipt of a path setup message from a client device, by using the virtual links in said database and transmitting a connection setup message; and
d) at a border node of the subnetwork, establishing a connection over the determined route, upon receipt of the connection setup message from said external node, by using only one virtual link of the advertised links.

29. The method of claim 28, wherein the external network node is connected to other external network nodes, and wherein step O) comprises the step of retransmitting the link state advertisement message to said other external nodes or discarding the message, depending on a predefined advertisement scope.

30. The method of claim 28, wherein step (d) comprises the step of transmitting a rejection message from the border node of the subnetwork to the external network node when there is no available virtual link to said destination.

31. The method of claim 28, wherein step (d) comprises the step of transmitting a rejection message from the border node of the subnetwork to the external network node when said connection setup message contains two or more of said virtual links.

32. The method of claim 28, wherein each of the virtual links has a minimum of link costs which would otherwise be incurred by possible candidate physical links, further comprising the steps of:
at each node of the subnetwork, recalculating said virtual links when one of the virtual links becomes unavailable for use and transmitting an update link state advertisement message for indicating the unavailability of the virtual link; and
at the external network node, receiving the update link state advertisement message and updating said database according to the received message.

33. The method of claim 32, further comprising the steps of:
at each node of the first subnetwork, recalculating said virtual links when said unavailable virtual link becomes available for use and transmitting an update link state advertisement message for indicating the availability of the virtual link; and
at the external network node, receiving the update link state advertisement message and updating said database according to the received message.
